(19) United States
(12) Patent Application Publication
(10) Pub. No.: US 2026/0021762 A1
(43) Pub. Date: Jan. 22, 2026

(54) AGRICULTURAL MACHINE LIGHT SYSTEM

(71) Applicant: Deere & Company, Moline, IL (US)

(72) Inventors: JASON C. EUBANKS, HEDRICK, IA (US); PATRICK L. HAMMES, BATAVIA, IA (US)

(21) Appl. No.: 18/779,396

(22) Filed: Jul. 22, 2024

(51) Int. Cl. B60Q 1/50; A01D 41/127; A01D 75/00; A01D 90/10

(52) U.S. Cl. CPC B60Q 1/543; A01D 41/1275; A01D 75/00; A01D 90/10

(57) ABSTRACT

A light system associated with an agricultural machine may include a sensor configured to sense a fill level in a storage container, a first light source configured to be selectively operated, one or more processors, and a non-transitory computer-readable storage medium coupled to the one or more processors and storing programming instructions for execution by the one or more processors. The programming instructions may instruct the one or more processors to determine the fill level of the storage container based on a sensor output of the sensor and operate the first light source according to a light parameter program based on the determined fill level. The first light source may be operated according to different light parameter programs for different fill levels.

### FIELD OF THE DISCLOSURE

The present disclosure relates generally to light systems and, more particularly, to light systems to identify a status or characteristic of an agricultural machine.

### BACKGROUND OF THE DISCLOSURE

Agricultural harvesters, such as combine harvesters, move through a field to harvest crop. In some instances, as the harvester harvests grain, a grain tank of the harvester fills with clean grain. The grain tank is unloaded when a level of the grain in the grain tank reaches a selected level. When unloading is desired, generally a grain cart is positioned adjacent to the harvester to receive the grain offloaded therefrom.

### SUMMARY OF THE DISCLOSURE

A first aspect of the present disclosure is directed to a light system associated with an agricultural machine. The light system associated with an agricultural machine may include a sensor configured to sense a fill level in a storage container; a first light source configured to be selectively operated; one or more processors; and a non-transitory computer-readable storage medium coupled to the one or more processors and storing programming instructions for execution by the one or more processors. The programming instructions may instruct the one or more processors to: determine the fill level of the storage container based on a sensor output of the sensor; and operate the first light source according to a light parameter program based on the determined fill level, the first light source operated according to different light parameter programs for different fill levels.

Another aspect of the present disclosure is directed to computer-implemented method performed by one or more processors for automatically controlling a light arrangement associated with an agricultural machine. The computer-implemented method may include detecting a fill level of a storage container of the agricultural machine based on a sensor output of a sensor and operating a first light source of the agricultural machine according to a light parameter program based on the detected fill level, the first light source operated at different light parameter programs corresponding to different fill levels.

Another aspect of the present disclosure is directed to a combine harvester. The combine harvester may include a body; a grain tank provided on the body and configured to store harvested grain; a sensor configured to sense the harvested grain in the grain tank; a first light source provided on the body; and an electronic controller. The electronic controller may include one or more processors and a non-transitory computer-readable storage medium coupled to the one or more processors and storing programming instructions for execution by the one or more processors. The programming instructions instruct the one or more processors to determine a fill level of the harvested grain in the grain tank based on an output of the sensor indicative of the sensed harvested grain and operate the first light source according to a selected manner responsive to the determined fill level, the selected manner being different for different fill levels.

The various aspects may include one or more of the following features. The light parameter program may include one or more of a light color, an arrangement of light colors, a light sequence, a light sequence rate, a light pattern, or a duration of light operation. The fill level may include a first fill level and a second fill level. The programming instructions that instruct the one or more processors to operate the first light source according to a light parameter program based on the detected fill level may include programming instructions that that instruct the one or more processors to operate the first light source according to a first light parameter program in response to the fill level being the first fill level and according to a second light parameter program in response to the fill level being the second fill level. The first light parameter program may be different than the second light parameter program. A second light source may be included, and the programming instructions may include programming instructions that instruct the one or more processors to operate the second light source according to a light parameter program based on a characteristic of the agricultural machine. The characteristic of the agricultural machine may include an identify of an operator of the agricultural machine. The programming instructions may include programming instructions that instruct the one or more processors to operate the second light source according to a light parameter program based on an association between the agricultural machine and other machine. The association between the agricultural machine and the other machine maty include one of an offloading machine and one of a receiving machine.

The various aspects may include one or more of the following features. Operating the first light source of the agricultural machine according to the light parameter program based on the detected fill level may include operating the first light source with one or more of a selected light color, a selected light sequence, a selected light sequence rate, or a duration of light operation based on the detected fill level. Operating the first light source of the agricultural machine according to the light parameter program based on the detected fill level may include operating the first light source according to a first light parameter program in response to the storage container having a first fill level and operating the first light source at a second light parameter program in response to the storage container having a second fill level. The first light parameter program may be different than the second light parameter program, and the first fill level may be different than the second fill level. The light parameter program may be a first light parameter program. A second light source of the agricultural machine may be operated according to a second light parameter program based on a characteristic of the agricultural machine. Operating the second light source of the agricultural machine according to the second light parameter program based on a characteristic of the agricultural machine may include operating the second light source based on an identity of an operator of the agricultural machine. The light parameter program may be a first light parameter program. A second light source of the agricultural machine may be operated according to a second light parameter program based on a pairing condition. The pair condition may include an association of the agricultural machine with another machine.

The various aspects of the present disclosure may include one or more of the following features. A second light source may be configured to be selectively operated. The programming instructions may include programming instructions configured to instruct the one or more processors to operate the second light source according to a characteristic of the agricultural combine harvester. The characteristic of the agricultural combine harvester may include an identify of an operator of the agricultural combine harvester. A third light source may be configured to be selectively operated. The programming instructions may include programming instructions configured to instruct the one or more processors to operate the third light source based on a pairing status of the agricultural combine harvester. The pairing status may include a status of the agricultural combine harvester being paired with a receiving vehicle configured to receive the harvested grain during an unloading operation of the agricultural combine harvester. The selected manner may include one or more of a color of illumination, an illumination sequence, an illumination sequence rate, or a duration of operation of the first light source.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a side view of an example combine harvester, according to some implementations of the present disclosure.

FIG. 2 is a front view of an example light arrangement that includes three vertically arranged light sources, according to some implementations of the present disclosure.

FIG. 3 is a front view of another example light arrangement that includes three laterally arranged light sources, according to some implementations of the present disclosure.

FIG. 4 is a front view of another example light arrangement having four light sources in a matrix configuration, according to some implementations of the present disclosure.

FIG. 5 is a schematic view of an example control system for controlling operation of one or more light sources, according to some implementations of the present disclosure, according to some implementations of the present disclosure.

FIG. 6 is a flowchart of an example method to control operation of one or more light sources associated with an agricultural machine based on a received input, according to some implementations of the present disclosure.

FIG. 7 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

As combine harvesters move through a field performing a harvesting operation, the combine harvesters collect the harvested crop from an agricultural header attached to the harvester and process the harvested crop. As a result of this processing, clean grain is produced and is stored in a grain tank of the combine harvester. As the fill level in the tank increases, the time when an unloading operation to offload the collected clean grain decreases. That is, as the grain tank fill level increases, a time when the grain tank is to be unloaded approaches. Currently, as the grain tank fills, a light source on the combine harvester may be operated at different grain fill levels. However, the manner in which the light source operates is the same for each grain fill level. Therefore, because the operation of the light source at the different fill levels is the same, the operation of the light fails to provide an indication of the actual fill level of grain in the grain tank. As such, an operator of a receiving vehicle, e.g., an operator of a tractor pulling a grain cart or other vehicle, lacks the ability to determine the fill level of grain in the grain tank when the light source is operated. As such, based on operation of the light source, the operator of the receiving vehicle is unable to ascertain when to position the receiving vehicle for unloading of the grain from the harvester to the receiving vehicle. With a receiving vehicle not positioned to accept clean grain from the harvester when unloading is needed or desired, a harvesting operation can be delayed. For example, if the grain tank of the harvester is filled and a receiving vehicle is not in position because operation of the light source fails to provide an indication of the actual fill level of the grain tank, then the combine harvester may have stop harvesting, thereby delaying a harvesting operation. This delay is costly both in time and money, such as in labor costs and fuel costs. Although combine harvesters are discussed, the present disclosure may be applicable to other types of agricultural machines, such as other types of agricultural harvesters.

Also, some harvesting operations involve multiple vehicles operating in the field at the same time. For example, in some cases, multiple combine harvesters and multiple receiving vehicles are simultaneously operating in a field during a harvesting operation. When a combine harvester is ready to unload or approaching a time when an unloading operation is needed or desired, identifying a receiving vehicle of the plurality of receiving vehicles present to receive the grain from the combine harvester is not readily apparent. That is, there is no visual indication of which receiving vehicle is tasked with receiving the grain from a combine harvester ready to preparing to unload grain. This lack of clarity, again, can waste time and increase costs (e.g., labor costs and fuel costs).

Additionally, when a plurality of agricultural vehicles is present in a field, for example, a plurality of combine harvesters, visually distinguishing one combine harvester from another may be difficult or not possible. As a result, delays may occur, which increase the time and costs associated with a harvesting operation. For example, if a combine harvester of a plurality of combine harvesters presently operating in a field to harvest crop experiences a problem, identifying, for example visually, the combine harvester experiencing a problem may be difficult to identify. As such, a time required to identify the combine harvester may increase and, as such, an amount of time that the combine harvester is unable to harvest crop increases costs associated with a harvesting operation.

The present disclosure provides systems and methods for a providing an indication, such as by operation of one or more light sources on a combine harvester, of a fill level of grain cart in a grain tank of the combine harvester. Further, the present disclosure also provides an indication by operation of one or more light sources of a characteristic of a combine harvester and an indication by operation of one or more light sources of a linking between the combine harvester and a receiving vehicle tasked with receiving grain from the combine harvester during an upcoming unloading operation. The present disclosure also provides systems and methods for visually identifying a combine harvester based on a characteristic of the combine harvester. Example characteristics include an operator identity, an operational status, or a geographic position.

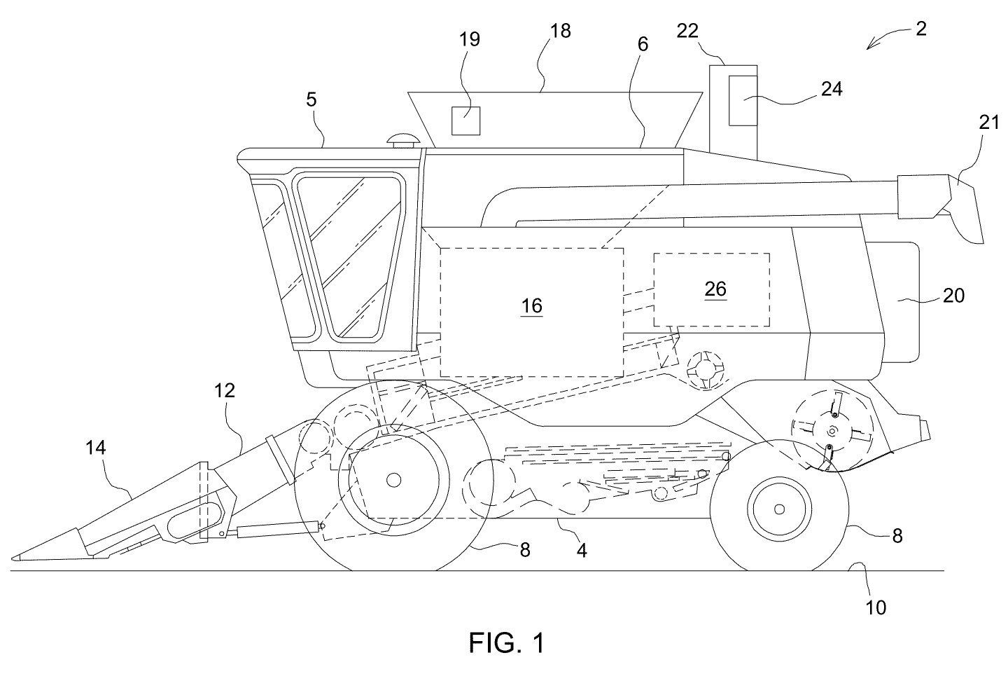

FIG. 1 is a side view of an example combine harvester 100. Although combine harvesters are described in the context of FIG. 1 and examples provided herein, the scope of the disclosure is not limited to combine harvester or agricultural harvesters more generally. Rather, the scope of the present disclosure encompasses other agricultural machines, particularly an agricultural machine that may require periodic attention or servicing during the course of an agricultural operation, such as refilling a commodity tank of a sprayer or grain tank of a planter or seeder. Further, the scope of the present disclosure also encompasses types of agricultural machines that are present at the same time during an agricultural operation and may otherwise be difficult to discern amongst the other agricultural machines of the same type.

The combine harvester 2 includes a frame 4, a cab 5, a body 6 mounted to the frame 4, and ground engaging components 8 coupled to the frame 4. The cab 5 is occupied by an operator who utilizes controls within the cab 5 to operate the combine harvester 2. The ground engaging components 8 operate to move the combine harvester 2 over a surface, such as the ground 10. Example ground engaging components 8 include wheels (e.g., a combination of wheels and tires), tracks, or other components or assemblies that function to move the agricultural harvester 2 over the ground 10. The combine harvester 2 also includes a feederhouse 12 to which an agricultural header 14 is removably attached. The combine harvester 2 includes processing components 16 within the body 6 that process the harvested crop. Clean grain extracted from the harvested crop is stored within a grain tank 18, and residue from the harvested crop is handled by a residue system 20.

During a harvesting operation, the header 14 operates to harvest crop and transport the harvested crop to the feederhouse 12. The feederhouse 12 conducts the harvested crop into the body 6 for processing by the processing components 16. The resulting clean grain is transported to the grain tank 18, and the resulting crop residue is conveyed to the residue system 20, from which the residue is expelled from the combine harvester 2. The combine harvester 2 also includes a grain fill level sensor 19 that senses a fill level of grain within the grain tank 18. In some implementations, the grain fill level sensor 19 is a grain tank full level sensor AH121475, produced by Deere & Co., One John Deere Pl, Moline, IL 61265. However, the scope of the present disclosure is not so limited. In other implementations, other example grain fill level sensors include a photo sensor, a potentiometer (e.g., a rotary potentiometer), a plurality of photo sensors, one or more pressure plates, or a lidar sensor. Other sensors may also be used. The combine harvester 2 also includes an unloader 21. The unloader 21 is used to transfer the clean grain from the grain tank 18 to a receiving vehicle, such as a grain cart pulled by a tractor. In some implementations, the unloader 21 includes a conveyor, such as an auger, that moves the clean grain from the grain tank 18 to the receiving vehicle.

The combine harvester 2 also includes a light arrangement 22 that includes one or more light sources 24. Example light sources include light emitting diodes (LEDs), incandescent light sources, and a matrix of independently controllable pixels. However, other types of technologies operable to generate light are also within the scope of the present disclosure, e.g., plasma displays, LED displays, etc. Although a single light arrangement 22 is shown, in other implementations, a plurality of light arrangements 22 may be included on combine harvester 2. For example, in some instances, a plurality of light arrangements 22 may be distributed to different locations on the combine harvester 2, such as locations that enable an observer to see light emitted by the light sources 24 independent of an orientation or position of the combine harvester 2 in a field. For example, in some instances, a combine harvester may include four light arrangements located at the lateral and longitudinal extents of the combine harvester. Other positions are also included within the scope of the present disclosure.

The light arrangement 22 is communicably coupled to a control system 26, such as via a wired or wireless connection. In some implementations, the control system 26 is a computer or computer system, such as computer 702 or computer system 700, as described in more detail below. The control system 26 is operable to control operation of the light arrangement 22 and, particularly, operation of the light sources 24 of the light arrangement 22. For example, the control system 26 is operable to control the light arrangement 22 to produce light having desired light parameters. For example, the control system 26 is operable to activate or deactivate the light sources 24 to produce illumination or cease producing elimination, respectively. In some implementations, a light source 24 may illuminate with a solid or uniform light color. In other instances, a light source 24 may illuminate with a plurality of different colors of light or have a selected pattern of light. Additionally, the control system 26 is operable to control a duration of illumination of the light sources 24, a color of illumination of the light sources 24 or a combination or arrangement of colors produced by each light source 24, a sequence of illumination of the light sources 24, a duration of time that the light sources 24 are operated, a rate at which a sequence of illumination is produced by the light sources 24, or another aspect of the operation of the light sources 24. Thus, example light parameters include whether a light source is activated or not activated, a light color, a plurality of light colors, a light arrangement, a light sequence, a rate at which a light sequence is produced, a pattern of light, a duration of operation, or a light brightness. Other light parameters are also within the scope of the present disclosure. A group of light parameters used to operate a light source may be referred to as a light parameter program. A light parameter program may be executed by a control system to control operation of light sources of a light arrangement to produce light having a desired appearance according to one or more light parameters, such as one or more light parameters described herein.

The control system 26 is operable to operate the light arrangement 22 to operate one or more light sources 24 in response to a sensed fill level of the grain tank 18. For example, the control system 26 is operable to receive an output from the grain fill level sensor 19, determine a fill level of the grain tank 18 based on the received output of grain fill level sensor 19, and control an operation of one or more light sources 24 in response to determined fill level of grain tank 18. For example, in some instances, the grain fill level sensor 19 may provide an output continuously to the control system 26. In some implementations, the grain fill level sensor 19 may provide output to the control system 26 at a selected interval, such as a time interval, a selected distance traveled by the combine harvester 2, or on another basis. In some implementations, each of the different grain fill levels has a corresponding light color or group of light parameters associated therewith. That is, in some instances, light generated by a light source is different for different fill levels of grain in the grain tank. In this way, a level of fill of the grain tank is quickly determined by visually inspecting light generated by one or more light sources 24 of the light arrangement 22.

In some implementations, the control system 26 is operable to operate a light source 24 of the light arrangement 22 at selected fill levels of the grain tank 18. For example, in some instances, the control system 26 is operable to operate the light source at a first selected fill level of the grain tank 18 (e.g., 25 percent of the full capacity of the grain tank 18), a second selected fill level of the grain tank 18 (e.g., 50 percent of the full capacity of the grain tank 18), a third selected fill level of the grain tank 18 (e.g., 75 percent of the full capacity of the grain tank 18), and a fourth selected fill level of the grain tank 18 (e.g., 100 percent capacity of the grain tank 18). The fill levels recited are merely examples, and, in other implementations, other fill levels can be selected. Further, although four fill levels are indicated, in other implementations, additional or fewer fill levels may be used.

When the control system 26 determines a selected fill level based on a signal or signals received from the grain fill level sensor 19, the control system 26 generates a control signal or signals to operate one or more of the light sources 24 in a selected manner. For example, when the control system 26 determines that a selected fill level exists, the control system 26 controls the light source 24 to illuminate with a selected light color. When another of the fill levels is determined, the control system 26 causes the light source 24 to illuminate with a different color of light. Thus, in some instances, a different color of light may be used for each determined fill level of the grain tank 18. For example, a first selected fill level may cause light source 24 to illuminate with a blue color of light. A second selected fill level may cause the light source 24 to illuminate with a green color of light, and so on. Still further, the control system 26 may operate the light source 24 with one or more other light parameters that differ for each selected fill level of the grain tank 18. For example, for each selected fill level of the grain tank 18, the control system 26 may cause the light source 24 generate light, for example, with a different brightness level, with a different rate of flashing of the light, with a different sequence of flashing of the light (e.g., a different patter of flashing light), with a different duration of operation (e.g., an amount of time that the light source flashes), with a different combination of colors, or a combination of two or more of these. In still other implementations, other types of variations of operation of the light source 24 may be used. In still other implementations, the control system 26 may operate more than one of the light sources 24 of the light arrangement 22 based on a fill level of the grain cart.

In some implementations, the manner in which the control system 26 operates one or more of the light sources 24 based on the existence of a selected fill level of the grain tank 18 is different from the way that the control system 26 operates one or more of the light sources at the other selected fill levels of the grain tank 18. By operating the one or more light sources 24 different at the different selected fill levels of the grain tank 18, an observer is able to readily identify what the fill level of the grain tank 18 is. For example, if the control system 26 operated one of the light sources 24 to illuminate a different color at each of the selected fill levels of the grain tank 18, then, based on the color of produced light by the light source 24, the observer can readily identify the amount of grain present in the grain tank 18. Although this example involves changing a color of light to indicate fill level of the grain tank, in other implementations, the control system 26 may cause the light source 24 to flash at different rates based on the fill level in the grain tank 18. Other parameters may also be altered, either alone or in combination with other parameters of the operation of the light source 24, based on the different selected fill levels of the grain tank 18. Thus, by operating the one or more light sources in this way, an observer can readily identify the fill level of the grain tank 18.

In some implementations, the one or more light sources 24 that indicate fill level are operated automatically based on a sensor output, such as a fill level sensor that is operable to sense a fill level of grain in the grain tank 18. In some instances, the sensor output is received by the control system 26, and, in response to that sensor output, the control system 26 determines a fill level of grain in the grain tank 18 and controls the one or more light sources to indicate the level of fill in the grain tank 18, such as, for example, by controlling a color of light produced by the one or more light sources 24.

In some implementations, the control system 26 operates one or more of the light sources 24 of the light assembly 22 based on a characteristic of the combine harvester 2. Although the combine harvester 2 is used as an example, one or more light sources of a light assembly can be operated to uniquely identify the agricultural machine from other agricultural machines, such as other agricultural machines operating simultaneously in a field during an agricultural operation. In some implementations, the one or more light sources 24 used to identify the combine harvester 2 is different than the one or more light sources 24 used to indicate another aspect, such as a fill level of grain in the grain tank 18. Example characteristics of the combine harvester 2 that may be used to identify the combine harvester 2 or distinguish the combine harvester 2 from other combine harvesters or agricultural machines in a field include operator identification, machine type (e.g., tractor, combine harvester, grain cart, etc.), machine make (e.g., the manufacturer of the machine), model (e.g., the model of machine), or some other characteristic that can be used to distinguish one agricultural machine from others present, such as other agricultural machines present in a field during an agricultural operation. Other characteristics may also be used.

In some instances, the characteristic information is input to the control system 26, such as via an input device. In some instances, the input device is located in the cab of the agricultural machines, such as cab 5 of the combine harvester 2, and an operator uses the input device to define a setting of one or more light sources to identify the agricultural machine. In other implementations, the characteristic information is input remotely, such as via a remote computer or electronic device, such as a desktop computer, a laptop computer, a mobile device (e.g., mobile phone), or another type of electronic device. In other instances, the characteristic may be saved on a memory device connected to or that forms part of the control system 26. For example, identification information of agricultural machines of a fleet may be preselected and saved for future references, such as in a computer file. When each of the agricultural machines in the fleet of agricultural machines is operated, the characteristic information may be recalled from memory, and the characteristic information may be used to control operation of one or more light sources to produce light having one or more desired parameters that can be used to distinguish one agricultural machine from others. For example, the control system 26 may receive the characteristic information, whether read from memory or received via an input device, and control operation of one or more light sources 24 based on the received characteristic information.

In some instances, a single light arrangement is used to communicate multiple pieces of information. For example, for a combine harvester having a light arrangement with two or more light sources, one of the light sources may be used to show a fill level of grain in a grain tank of the combine harvester and a different light source is used to show a unique identifier of the combine harvester. For a given light arrangement, a position of the light source relative to the other light sources, may be used to clearly identify which light source communicates which characteristic. For example, for a vertical light arrangement, an uppermost light source may be selected to indicate grain fill level, and a light source immediately below the uppermost light source may be used to identify the particular machine.

In some instances, machine characteristic information has associated light parameters, such as light color. Other types of light parameters, such as one or more of the light parameters listed above or otherwise within the scope of the present disclosure, may be used to produce a desired type of light from one or more of the light sources 24 to distinguish one agricultural machine in the field from other agricultural machines in the field. For example, in some implementations, each machine is the field uses one or more light sources 24 to produce a unique identifier that distinguishes each agricultural machine from others present during an agricultural operation. For example, in some instances, each different agricultural machine in a field or each machine of a particular type or group of machines may have a different color associated with the particular machine. For example, if four combine harvesters were in a field at the same time performing a harvesting operation, each combine harvester has different light color as a unique identifier. In that way, each combine harvester is distinguishable from the other combine harvesters. Further, in some implementations, each machine in the field can have a unique light color or other light parameter or parameters that allow each machine to be uniquely identified or distinguished from the other machines.

One or more light sources 24 may also be used to indicate a pairing condition. For example, when a level of grain in the grain tank 18 reaches a selected level, the combine harvester 2 is ready to perform an unloading operation to transfer the grain in the grain tank 18 to a receiving vehicle, such as grain cart. In response to the level of grain in the grain tank 18 reaching a selected level, the control system 26 may transmits a signal to indicate that an unloading operation is desired. In response to the signal, a receiving vehicle is selected for receiving grain from the combine harvester 2. For example, the receiving vehicle having capacity to receive all or a portion of the grain in the grain tank 18 may be paired with the combine harvester 2. Other information may be used to select a receiving vehicle for pairing with the combine harvester 2, such as a location of the combine harvester 2, a location of the receiving vehicle, a fill level of the receiving vehicle, a direction of travel of the receiving vehicle, or one or more properties of the field (e.g., topography, field moisture, obstacles, etc.). In some implementations, a light source of a light arrangement used to indicate a pairing condition is different from other light sources of the light arrangement that may be used to indicate other aspects, such as grain fill level or machine identification.

In some implementations, a pairing determination (e.g., selection of a receiving vehicle for an unloading operation associated with a particular combine harvester) is made by a control system on the combine harvester, such as control system 26. Similarly, in some implementations, a control system on the combine harvester may also select the light parameter or parameters associated with pairing and transmit the light parameter information to the selected receiving vehicle. In some instances, the light parameter information is transmitted directly to the receiving vehicle. In other implementations, the light parameter information is transmitted indirectly to the receiving vehicle, such as via the Internet. In other implementations, selection of the receiving vehicle, the light parameter or parameters, or both is performed by a control system 26 provided on the receiving vehicle and communicated to the combine harvester directly or indirectly, as described above. For example, one or more receiving vehicles present during an agricultural operation may receive a request from a combine harvester for a receiving vehicle for an unloading operation. In some instances, each of the one or more of the receiving vehicles may determine, using one or more criteria, whether the receiving vehicle is appropriate to pair with the requesting combine harvester. The receiving vehicle that determines itself or is otherwise determined to be the appropriate receiving vehicle may transmit that information to the other receiving vehicles, to the combine harvester, or both. In some instances, the selected receiving vehicle may also transmit to the combine harvester the light parameter or parameters associated with pairing, and the combine harvester can utilize that information to generate light with the selected light parameter or parameters. For example, a control system of the receiving vehicles, which may be similar to control system 26, makes these determinations.

In other implementations, selection of the receiving vehicle, the light parameter or parameters, or both is performed remotely, such as by a remotely located control system, which may be similar to control system 26. In some instances, the remotely located control system is in communication with the machines performing an agricultural operation, such as all of the machines or some group of the machines. For example, in some instances, the remotely located control system is in communication with an entirety of the combine harvesters and the receiving vehicles performing an agricultural operation. When one of the combine harvesters requests a receiving vehicle, such as by indicating the need for an unloading operation (e.g., based on grain level in a grain tank), then the remotely located control system selects one of the receiving vehicles for the unloading operation (e.g., based on satisfying one or more criteria) and pairs the selected receiving vehicle and the combine harvester. In some implementations, the remotely located control system selects one or more light parameters and transmits the light parameter information to the combine harvester and the selected receiving machine so that both machines produce light the same light parameters. In still other implementation, the selection of a receiving vehicle for pairing, the light parameters, or both may be distributed to a control system on the combine harvester, a control system on the receiving vehicle, a remotely located control system, or a combination of these. Thus, in some instances, decisions regarding pairing and light parameters, for example, may be distributed over two or more control systems. Although this description is made in the context to combine harvesters and receiving vehicles, the scope is not so limited but encompasses pairing of other types of vehicles, such as other agricultural machines or construction machines.

When pairing between the combine harvester 2 and a receiving vehicle is made, both the combine harvester 2 and the receiving vehicle produce light having the same parameters. For example, one or more of the light sources 24 on the combine harvester 2 produces light having one or more selected parameters and one or more corresponding light sources on the receiving vehicle produces light having the same one or more selected parameters. For example, in some instances, a light source 24 of the combine harvester 2 produces light having a selected color and a light source of the receiving vehicle also produces light having the same selected color. In this way, an observer can readily identify that a pairing exists between the combine harvester 2 and the receiving vehicle.

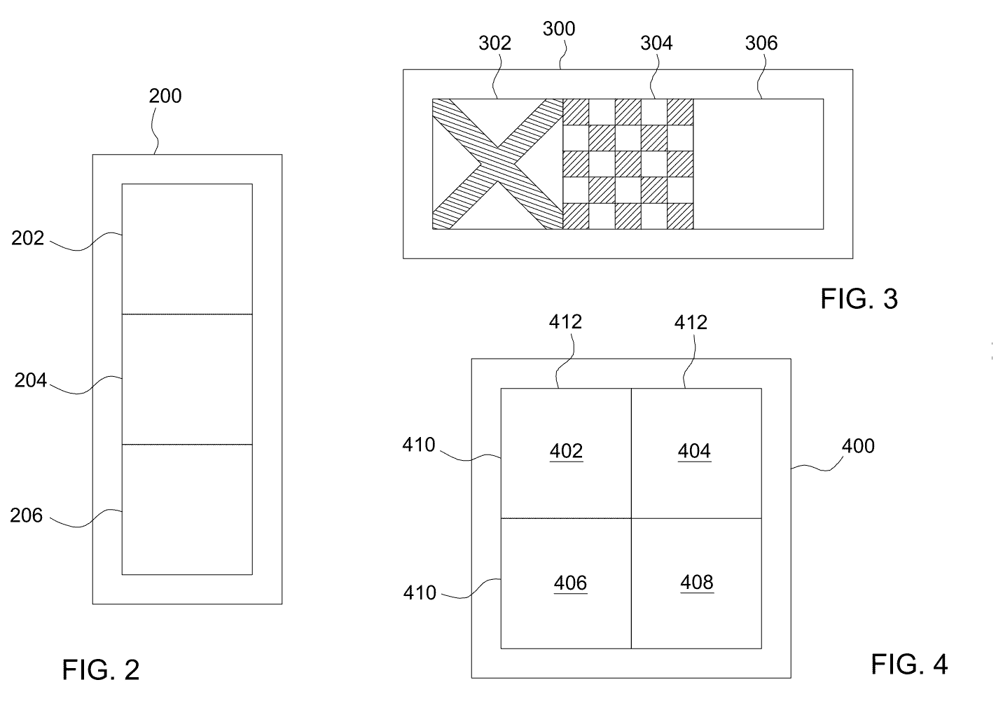

It is noted that a light arrangement, such as light arrangement 22, can use the light sources thereof (e.g., light sources 24) to indicate multiple characteristics. Referring to FIG. 2, an example light arrangement 200 is shown. The example light arrangement 200 may be similar to light arrangement 24 and includes three light sources 202, 204, and 206, which may be similar to light source 24. Although the light source 200 includes three light sources, in other implementations, the light arrangement 200 may include additional or fewer light sources. Thus, in some implementations, the light arrangement 200 may include any number of light sources. In the illustrated example, the light sources 202, 204, and 206 have a vertical arrangement. However, in other implementations, the light sources 202, 204, and 206 may have a different arrangement. For example, light sources may be arranged horizontally, as shown, for example, in FIG. 3, or have any other desired arrangement.

In some implementations, the light source 202 is used to indicate a level of grain in a grain tank of a combine harvester; the light source 204 is used to identify the agricultural machine to which the light arrangement 200 is attached; and the light source 206 is used to indicate a pairing. Each light source may be operated to produce light having one or more light parameters as described herein or otherwise within the scope of the present disclosure, e.g., color or colors, sequence, pattern, duration, brightness, etc.

FIG. 3 is front view of another example light arrangement 300. The light arrangement 300 includes three light sources 302, 304, and 306 arranged horizontally. Each of the light sources 302, 304, and 306 is configured to generate light according to one or more light parameters, such as one or more of the light parameters described herein. For example, in the illustrated example, light source 302 generates a pattern of light that forms an “X,” with the “X” being one color and the portion of the light source 302 not forming the “X” being another color. For example, in some implementations, one or more of the light sources is formed of a plurality of pixels arranged in a matrix, and each pixel is selectively and independently operated relative to the other pixels. Consequently, a light source of this type is operable to generate an image, such as a character or other symbol. Light sources 304 and 306 may be similar to light source 302. Consequently, as shown in FIG. 3, the pixels of light source 306 form a checker pattern, and pixels of the light source 306 produces a light of a single color. In some instances, one or more of the light sources 302, 304, or 306 may flash at a selected rate or generate animation based on selected operation of the pixels of the light source (such as in response to execution programming instructions of software, such as software 530, described below). In other implementations, the light sources may produce light according to other selected parameters.

FIG. 4 is a front view of another example light arrangement 400. The light arrangement 400 includes light sources 402, 404, 406, and 408, which may be any type of light source described herein or otherwise within the scope of the present disclosure. In this example, the light sources are arranged in a series of rows 410 and columns 412. However, other arrangements of light sources are also within the scope of the present disclosure.

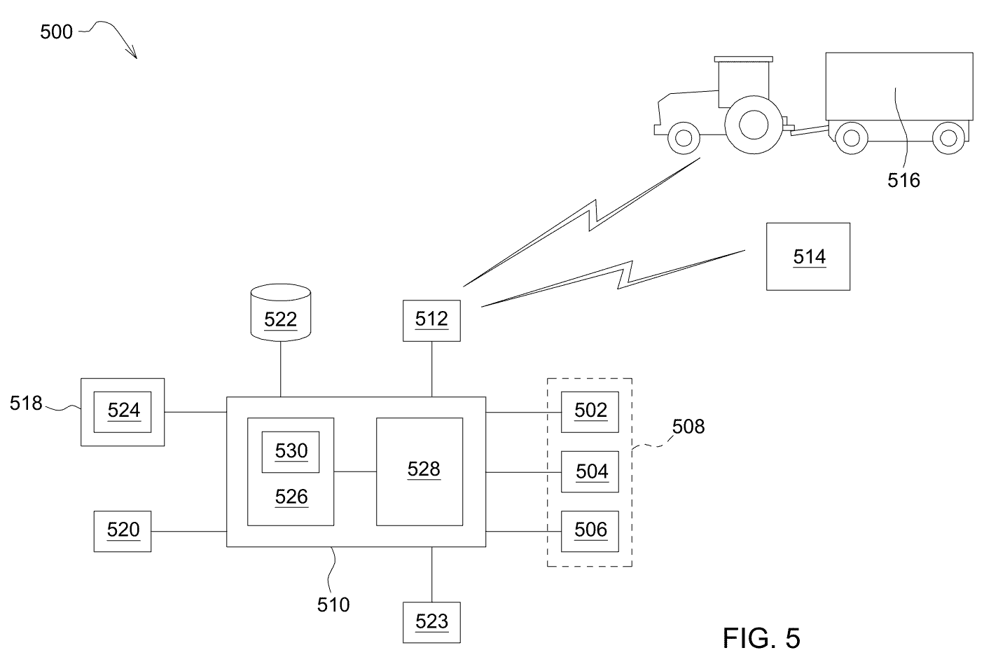

FIG. 5 is a schematic view of an example control system 500 for controlling operation of a light sources 502, 504, and 506 that form a light arrangement 508, which may be similar to light arrangement 22, 200, 300, or 400. Although three light sources are illustrated, in other implementations, additional or fewer light sources may be used. As explained herein, operation of one or more of the light sources may be used to indicate, for example, a fill level of grain in a grain tank of a combine harvester, a characteristic of an agricultural machine (which, for example, may uniquely identify the agricultural machine from other agricultural machines present during an agricultural operation), or a pairing condition of an agricultural machine. The light sources may be used to provide other indications.

The control system 500 may be similar to the control system 26 or other control systems described herein and operate as described herein. The control system 500 includes an electronic controller 510. The controller 510 may be a computer or computer system, such as computer 702 or computer system 700. The control system 500 also includes the light sources 502, 504, and 506 and a transceiver 512. The transceiver 512 is operable to receive or transmit information, such as pairing information (e.g., an identification of a receiving vehicle that is paired with a combine harvester during an unloading operation), light parameter information, or other types of information from or to a remotely located control system 514, a receiving vehicle 516, another source, or a combination of these. In some implementations, information transmitted to or from a receiving vehicle is transmitted to or from a cart or a vehicle transporting the cart. The control system 500 also includes a display 518, input device 520, and a database 522. Additional or fewer input devices may be included. In some implementations, the display 518 and the database 522 may be omitted. In some instances, the database 522 is a memory storage device that stores information used or associated with the controller 510. For example, the database 522 may store information related to characteristics of agricultural machines, such as make, model, type, operator identification, or other information. In some instances, the database 522 may store other types of information, such as information related to the light sources 502, 504, and 506, or agricultural vehicles, such as combine harvesters and receiving vehicles performing an agricultural operation. The database 522 may be located remotely.

The control system 500 also includes a sensor 523. In some implementations, the sensor 523 is a grain fill level sensor that is operable to sense a level of grain in a grain tank of a combine harvester. In some implementation, the sensor 523 is similar to grain fill level sensor 19.

The display 518 is operable to display information related to operation of the control system 500, such as information related to operation of the light sources 502, 504, and 506. For example, the display 518 may display whether the light sources 502, 504, and 506 are activated and light parameters being used to control the light sources 502, 504, and 506 and, hence, the type of light being generated by each of the light sources 502, 504, and 506. The display 518 may also display information regarding pairing of agricultural machines, a fill level of grain in a grain tank of a combine harvester, or identification information associated with one or more agricultural machines. In some instances, the information displayed by the display 518 is displayed via a graphical user interface (GUI) 524. Example graphical user interfaces are described in more detail below. In some implementations, the display 518 is a touch screen that is operable to receive input from a user via a user’s touch.

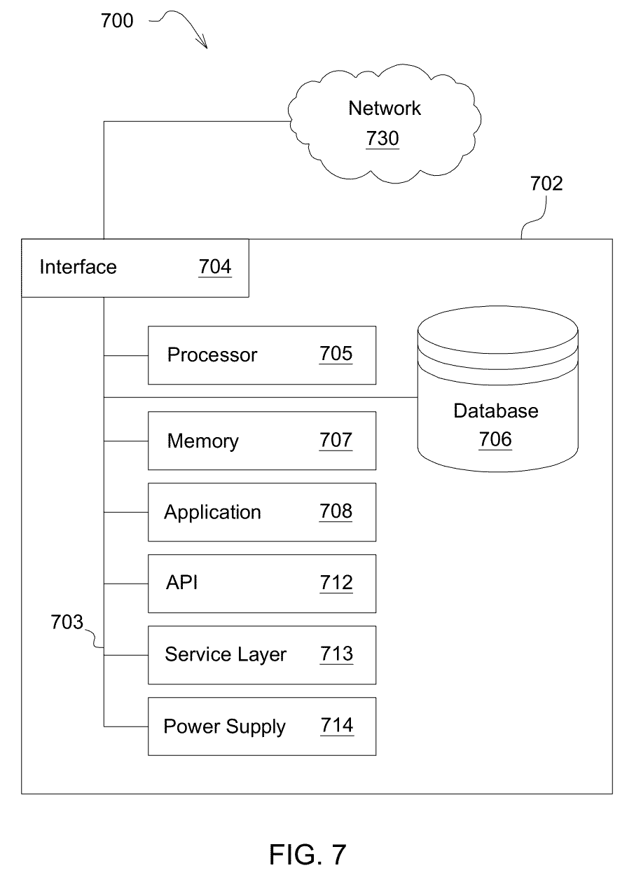

The controller 510 includes a processor 526 and a memory 528 communicably coupled to the processor 526. Additional details of the controller 510, such as processor 526 and memory 528, are described below in the context of computer 702. In some implementations, the controller 510 is communicably coupled with a network, such as in a manner described in more detail below in the context of FIG. 7. The memory 528 communicates with the processor 526 and is used to store programs and other software, information, and data. The processor 526 is operable to execute programs and software and receive information from and send information to the memory 528. Although a single memory 528 and a single processor 526 are illustrated, in other implementations, a plurality of memories, processors, or both may be used. Although the processor 526 and the memory 528 are shown as being local components of the controller 510, in other implementations, one or both of the processor 526 and memory 528 may be located remotely. The various components of the control system 500 are communicably coupled to the controller 510, such as via a wired or wireless connection.

Software 530, such as in the form of an application or program, is executed by the processor 526 to control operation of the control system 500, as described herein. Particularly, the software 526 includes executable programming instructions operable to control operation of the various components communicably coupled to the controller 510. For example, the software 530 includes executable programming instructions to control operation of the light arrangement 508 and, more particularly, the light sources 502, 504, and 506, as described herein. The software 530 also includes programming instructions to control operation of the light sources 502, 504, and 506 in response to information received or transmitted by the controller 510, e.g., via transceiver 512, or in response to signals received from sensor 523. The software 530 includes instructions to cause the processor 526 to perform example method 600, described in more detail below.

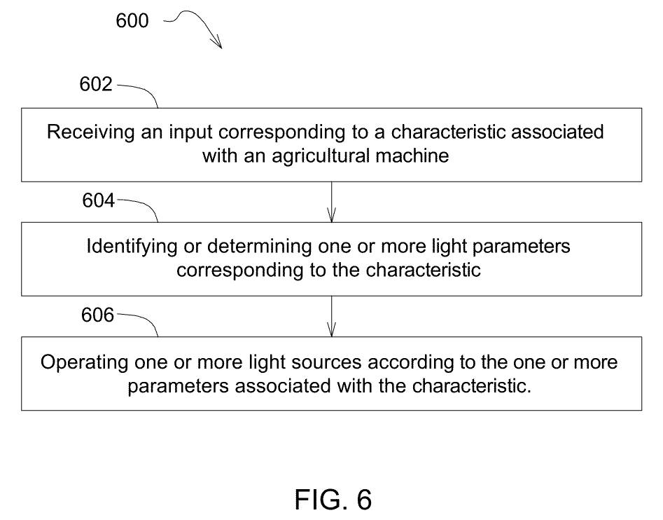

FIG. 6 is a flowchart of an example method for controlling one or more light sources of a light arrangement, such as light arrangement 22, 200, 300, 400, or another light arrangement within the scope of the present disclosure, according to one or more selected light parameters. At 602, an input corresponding to a characteristic associated with an agricultural machine is received. In some implementations, a plurality of inputs, with each input corresponding to a different characteristic, is received. For example, an input from a grain fill level sensor, such as grain fill level sensor 19 or sensor 523, may be received by a control system, such as control system 26 or control system 500. In some instances, one or more inputs are received by a control system from a remote location, such as via a signal transmitted from a remote location to an agricultural machine. In some instances, one or more inputs are received by a control system via an input device of an agricultural machine, such as an input device of a combine harvester. At 604, one or more light parameters associated with the characteristic are determined or identified. In some instances, one or more light parameters, which may include one or more of the light parameters described above, corresponding to each of a plurality of received characteristics is determined or otherwise identified. For example, each characteristic, whether a grain fill level, a machine characteristic, or a pairing condition, has an associated light parameter or parameters associated therewith. In some instances, each of the light parameter or parameters associated with the different characteristics are different. In this way, an observer can readily identify what each parameter or set of parameters produced by a light source is indicating, e.g., a grain fill level, a machine identifier, or a pairing condition. At 606, one or more light sources are operated (e.g., illuminated) according to the one or more light parameters associated with the received characteristic. In some instances, the one or more light sources associated with a characteristic are exclusively used to indicate that characteristic. Thus, light sources used to indicate a characteristic are separate from light sources used to indicate other characteristics.

The method 600 can be varied to include addition, fewer, or different features. For example, in some instances, one or more light parameters for a received characteristic may be determined using a look-up table contained, for example, in an electronic file stored in electronic memory. Further, the various features of method 600 may be rearranged and still be within the scope of the present disclosure.

Without in any way limiting the scope, interpretation, or application of the claims appearing below, a technical effect of one or more of the example implementations disclosed herein is the ability to readily identify a status of a particular agricultural machine, for example a particular grain fill status of a combine harvester during a harvesting operation. In this way, a delay in performing an unloading operation can be reduced or eliminated. Another technical effect of one or more of the example implementations disclosed herein is the ability to identify and distinguish a particular agricultural machine present during an agricultural operation from other agricultural machines present during the agricultural operation. Another technical effect of one or more of the example implementations disclosed herein is the ability to identify agricultural machines paired during the course of an agricultural operation, such as a combine harvester being paired with a receiving vehicle that receiving is to receive grain from the combine harvester during an unloading operation.

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface’s hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user’s client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A light system associated with an agricultural machine, the light system comprising:
a sensor configured to sense a fill level in a storage container;
a first light source configured to be selectively operated;
one or more processors; and
a non-transitory computer-readable storage medium coupled to the one or more processors and storing programming instructions for execution by the one or more processors, the programming instructions instruct the one or more processors to:
determine the fill level of the storage container based on a sensor output of the sensor; and
operate the first light source according to a light parameter program based on the determined fill level, the first light source operated according to different light parameter programs for different fill levels.

2. The light system of claim 1, wherein the light parameter program includes one or more of a light color, an arrangement of light colors, a light sequence, a light sequence rate, a light pattern, or a duration of light operation.

3. The light system of claim 1, wherein the fill level includes a first fill level and a second fill level and wherein the programming instructions that instruct the one or more processors to operate the first light source according to a light parameter program based on the detected fill level includes programming instructions that that instruct the one or more processors to operate the first light source according to a first light parameter program in response to the fill level being the first fill level and according to a second light parameter program in response to the fill level being the second fill level, the first light parameter program being different than the second light parameter program.

4. The light system of claim 1, further comprising a second light source,
wherein the programming instructions include programming instructions that instruct the one or more processors to operate the second light source according to a light parameter program based on a characteristic of the agricultural machine.

5. The light system of claim 4, wherein the characteristic of the agricultural machine includes an identify of an operator of the agricultural machine.

6. The light system of claim 1, further comprising a second light source,
wherein the programming instructions include programming instructions that instruct the one or more processors to operate the second light source according to a light parameter program based on an association between the agricultural machine and other machine.

7. The light system of claim 6, wherein the association between the agricultural machine and the other machine includes one of an offloading machine and one of a receiving machine.

8. A computer-implemented method performed by one or more processors for automatically controlling a light arrangement associated with an agricultural machine, the method comprising the following operations:
detecting a fill level of a storage container of the agricultural machine based on a sensor output of a sensor; and
operating a first light source of the agricultural machine according to a light parameter program based on the detected fill level, the first light source operated at different light parameter programs corresponding to different fill levels.

9. The computer-implemented method of claim 8, wherein operating the first light source of the agricultural machine according to the light parameter program based on the detected fill level includes operating the first light source with one or more of a selected light color, a selected light sequence, a selected light sequence rate, or a duration of light operation based on the detected fill level.

10. The computer-implemented method of claim 8, wherein operating the first light source of the agricultural machine according to the light parameter program based on the detected fill level comprises operating the first light source according to a first light parameter program in response to the storage container having a first fill level and operating the first light source at a second light parameter program in response to the storage container having a second fill level, the first light parameter program being different than the second light parameter program and the first fill level being different than the second fill level.

11. The computer-implemented method of claim 8, wherein the light parameter program is a first light parameter program, and further comprising operating a second light source of the agricultural machine according to a second light parameter program based on a characteristic of the agricultural machine.

12. The computer-implemented method of claim 11, wherein operating the second light source of the agricultural machine according to the second light parameter program based on a characteristic of the agricultural machine includes operating the second light source based on an identity of an operator of the agricultural machine.

13. The computer-implemented method of claim 8, wherein the light parameter program is a first light parameter program, and further comprising operating a second light source of the agricultural machine according to a second light parameter program based on a pairing condition.

14. The computer-implemented method of claim 13, wherein the pair condition includes an association of the agricultural machine with another machine.

15. An agricultural combine harvester comprising:
a body;
a grain tank provided on the body, the grain tank configured to store harvested grain;
a sensor configured to sense the harvested grain in the grain tank;
a first light source provided on the body; and
an electronic controller including:
one or more processors; and
a non-transitory computer-readable storage medium coupled to the one or more processors and storing programming instructions for execution by the one or more processors, the programming instructions instruct the one or more processors to:
determine a fill level of the harvested grain in the grain tank based on an output of the sensor indicative of the sensed harvested grain; and
operate the first light source according to a selected manner responsive to the determined fill level, the selected manner being different for different fill levels.

16. The agricultural combine harvester of claim 15, further comprising:
a second light source configured to be selectively operated,
wherein the programming instructions further include programming instructions configured to instruct the one or more processors to operate the second light source according to a characteristic of the agricultural combine harvester.

17. The agricultural combine harvester of claim 15, wherein the characteristic of the agricultural combine harvester includes an identify of an operator of the agricultural combine harvester.

18. The agricultural combine harvester of claim 15, further comprising:
a third light source configured to be selectively operated,
wherein the programming instructions further include programming instructions configured to instruct the one or more processors to operate the third light source based on a pairing status of the agricultural combine harvester.

19. The agricultural combine harvester of claim 18, wherein the pairing status includes a status of the agricultural combine harvester being paired with a receiving vehicle configured to receive the harvested grain during an unloading operation of the agricultural combine harvester.

20. The agricultural combine harvester of claim 15, wherein the selected manner comprises one or more of a color of illumination, an illumination sequence, an illumination sequence rate, or a duration of operation of the first light source.
